(19) United States
(12) Patent Application Publication
(10) Pub. No.: US 2005/0156744 A1
(43) Pub. Date: Jul. 21, 2005

(54) Diaper wetness annunciator system

(76) Inventor: Harold George Pires, Easton, PA (US)

Correspondence Address: Benita J. Rohm, 12 Rathbone Place, Grosse Pointe, MI, 48230, US

(21) Appl. No.: 10/997,825

(22) Filed: Nov. 23, 2004

Related U.S. Application Data
(63) Continuation-in-part of application No. PCT/US04/28464, filed on Aug. 31, 2004.
(63) Continuation-in-part of application No. 10/723,604, filed on Nov. 25, 2003.
(60) Provisional application No. 60/499,191, filed on Sep. 2, 2003.

(51) Int. Cl. G08B 23/00

(52) U.S. Cl. 340/573.5; 340/604

(57) ABSTRACT

A monitoring system identifies a wet diaper by embedding an inexpensive disposable passive humidity sensor, which may be formed of conductive ink, and attaching to the outside of the diaper a detachable transmitting module that is triggered into transmission by the humidity sensor. The transmitting module is sealed and transferable from the wet diaper to a dry one. Uniquely coded data is wirelessly transmitted to a remote receiver. The receiver may be a battery powered portable unit carried by the baby's guardian. In a day care center a multiple function receiver can identify any of several diapers. In hospitals, several strategically located receivers are each capable of recognizing and reporting any wet diaper within its range to a central computer. Low cost and long range are achieved by using a detachable and transportable active transmitter that is not discarded with the wet diaper and therefore can be re-used. False transmissions are prevented by a confirmatory resistance.

### RELATIONSHIP TO OTHER APPLICATION

This application is a continuation-in-part patent application of U.S. Ser. No. 10/723,604, filed Nov. 25, 2003, which claims the benefit of Provisional U.S. Patent Application Ser. No. 60/499,191, filed on Sep. 2, 2003, the disclosures of which are incorporated herein by reference.

### BACKGROUND OF THE INVENTION

1. Field of the Invention

This invention relates generally to systems for determining a physical environmental condition from a remote location, and more particularly, to a simple and economical system for announcing a wet diaper condition at a remote monitor.

2. Description of the Related Art

There is a need for a system that announces to a care giver that a diaper needs to be changed. Babies, for example, wet their diapers any time during the day or night, and without regard to whether they are in or out of their homes. There is a need for parents to be notified when this happens. Child care centers that tend to a number of babies simultaneously will change diapers at regular intervals to be on the safe side. Identifying and notifying the care giver that a diaper actually needs to be changed would save unnecessary changing of diapers and effect a reduction in diaper and labor costs. There is also a need in hospitals to check diapers worn by patients, many of whom are not able to notify the care givers that diaper changes are necessary. Hospital personnel, therefore, must make repeated checks on the diapers, which not only is an unpleasant task, but also consumes the limited human resources of the hospital.

Several attempts have been made in the prior art to identify wet diapers. The simplest known systems use one or more substances, such as a chromophore, that change color when wet. Other known arrangements contain transducers that change conductivity when wet and transfer this information to a passive electronic circuit that in turn is interrogated wirelessly by an external transmitter/receiver. The external transmitter/receiver in such known arrangements must be located within a few feet of the diaper. Other methods employ electronic transmitters located near the patient and connected by wires to the diaper. Still others have the transmitter on the body of the patient connected by wires. All of these systems are characterized by one or more disadvantages, such as inconvenience, high cost, or limited range of effectiveness, rendering them unacceptable in a large multi-patient environment, or where extended distances exist between the patients or a baby, and a monitoring station. For instance, the change in color concept still requires hospital staff to visit and examine the patient on a regular basis. The passive electrical system has a limited range and is inconvenient. Methods that require the patient to be wired to a separate unit are equally unacceptable because they require staff to make electrical connections or to change batteries. Moreover, additional wiring is uncomfortable to the patient, and limits his or her mobility.

It is, therefore, an object of this invention to provide a diaper wetness detecting system that employs a direct electrical connection between the wetness detector and a conveniently transportable transmitter.

It is another object of this invention to provide a diaper wetness detecting system that can be used to identify specific ones of wet diapers in a hospital ward, child care center, or other location where a plurality of individuals in close relation to one another wear diapers that need to be monitored.

### SUMMARY OF THE INVENTION

The foregoing and other objects are achieved by this invention which provides a system for monitoring the wetness condition of a diaper. In accordance with the invention, there is provided a sensor coupled to the diaper, the sensor having a first predetermined electrical characteristic when the associated diaper is dry and a second predetermined electrical characteristic when the associated diaper is wet. A detachable transmitter is installable on the diaper. When installed on the diaper, the detachable transmitter is electrically coupled to the sensor. In its operation, the detachable transmitter has a quiescent mode when the sensor is characterized by the first predetermined electrical characteristic and a transmission mode when the sensor is characterized by the second predetermined electrical characteristic. When in the transmission mode, the detachable transmitter transmits electromagnetic energy signals. A receiver is provided for receiving the electromagnetic energy signal transmissions from the detachable transmitter when the detachable transmitter is in the transmission mode.

In one embodiment of the invention, there is provided a coupling arrangement for simultaneously coupling the detachable transmitter onto the diaper and forming the electrical coupling with the sensor. The coupling arrangement includes a snap arrangement formed of first and second detachably engaging portions, the first engaging portion being installed on the diaper and electrically coupled to the sensor, and the second engaging portion being installed on the detachable transmitter and electrically coupled thereto. In a particularly advantageous embodiment of the invention, the first engaging portion is a female conductive portion of the snap arrangement and the second engaging portion is a male conductive portion of the snap arrangement. The conductive elements preferably are rustproof.

The coupling arrangement may alternatively be a film operating as a backing material, which is coated with electrically conductive adhesive that retains its tacky state indefinitely. This film would be placed on the inside surface of an outer layer of the diaper and be capable of presenting its tacky surface to the tabs on the transmitter, through a pair of holes in the outer layer of the diaper as described later. Another coupling arrangement to avoid the need for making the holes would be to construct the transmitter with a hinged flap, with the electrical tabs on the flap. This embodiment of the transmitter, when installed on the diaper, would have the hinge above the waistband, with the transmitter portion on the outside of the diaper and the hinged flap on the inside of the diaper. The contacts would be located on the hinged flap and on the side of the flap that faces the transmitter. This embodiment would permit the conductive ink lines on the diaper to remain only on the inner surface of an outer layer. There would be no need for holes in the outer diaper layer, for the purpose of permitting the transmitter contacts to make electrical connection to the conductive ink lines.

In a further embodiment, the detachable transmitter is provided with a visual indicator responsive to the detachable transmitter being in the transmission mode. Therefore, the system permits visual inspection by a care giver without the need to have access to the receiver or to check manually for wetness.

It is preferred that the detachable transmitter be contained within a waterproof sealed housing. Thus, the detachable transmitter can easily be washed and disinfected, and reused, thereby effecting significant savings in system cost. Also, it is preferred in certain embodiments that the receiver be portable so that it can be carried about in the pocket or on the belt of the care giver. Such a portable receiver may be battery operated.

In a still further embodiment of the invention, the detachable transmitter issues an identifier code when in the transmission mode, the identifier code being encoded in the electromagnetic energy signals. The receiver is arranged to produce a human readable indication associated with the detachable transmitter in response to the identifier code. In this manner, a care giver can readily identify the particular patient or child that is in need of a diaper change.

In accordance with a further system aspect of the invention for monitoring the wetness condition of a diaper, there is provided a sensor associated with the diaper, the sensor having a first predetermined electrical characteristic when the associated diaper is dry and a second predetermined electrical characteristic when the associated diaper is wet. The sensor, in a simple form, consists of two electrodes placed longitudinally (namely from the front, around the crotch area to the back of the diaper), spaced approximately half an inch apart, on the inside surface of an outer layer. The electrodes may be constructed of uninsulated wires, or be formed from conductive ink deposited on the inner surface of an outer layer of the diaper. The two electrodes would thus be in contact with the absorbent later. When the absorbent layer gets wet, the resistance between the electrodes would decrease substantially. A detachable transmitter is installed on the diaper and coupled electrically to the sensor, the detachable transmitter having a quiescent mode responsive to the sensor when the associated diaper is dry and a transmission mode responsive to the sensor when the associated diaper is wet. In addition, the detachable transmitter transmits a unique identification code within electromagnetic energy signals that are transmitted when the detachable transmitter is in the transmission mode. A receiver receives the electromagnetic energy signal signals from the detachable transmitter and issues a perceptible indication, the perceptible indication being responsive exclusively to the identification code transmitted by the detachable transmitter.

In one embodiment of this further aspect of the invention, the electromagnetic energy signals are in the radio frequency range. Of course, other forms of electromagnetic energy maybe used in the practice of the invention, including electromagnetic energy signals in the infrared and/or other frequency ranges. Irrespective of the nature of the electromagnetic energy signals being used in the practice of the invention, the receiver can be configured to be portable, as previously noted.

Also as previously noted, there is provided a coupling arrangement for simultaneously coupling the detachable transmitter onto the diaper and forming an electrical coupling between the detachable transmitter and the sensor. Conventional metallic or otherwise electrically conductive snaps, or electrically conductive adhesive elements, can be used for this purpose.

In accordance with a still further aspect of the invention, there is provided a system for monitoring a plurality of diapers, each diaper being worn by a respective one of a plurality of patients. A plurality of sensors is provided, each associated with a respective one of the diapers. Each sensor has a first predetermined electrical characteristic when the associated diaper is dry and a second predetermined electrical characteristic when the associated diaper is wet. A plurality of independent transmitters are coupled to each of an associated sensor, each transmitter having a quiescent mode when the associated diaper is dry and a transmission mode when the associated diaper is wet. Each such transmitter, when in a transmission mode, transmits independent bursts of electromagnetic energy signals at respective intervals. There is additionally provided a receiver for receiving the electromagnetic energy signal transmissions from each of the plurality of independent transmitters that is in its transmission mode, each electromagnetic energy signal transmission containing information responsive to a transmitter identification code of the respective transmitting independent transmitter.

In one embodiment of this aspect of the invention, there is further provided a transmitter identification code generator in each of the plurality of independent transmitters for generating the associated transmitter identification code. In an advantageous embodiment of the invention, there is provided a programming station for programming each of the independent transmitters with a patient identification code responsive to the identification of a respectively associated patient. A control processor processes the information contained within each transmission.

In accordance with another aspect of the invention, there is provided a system for monitoring a plurality of diapers, each diaper being worn by a respective on of a plurality of patients. A plurality of sensors, each associated with a respective one of the diapers, is included within the system. Each sensor has a first predetermined electrical characteristic when the associated diaper is dry and a second predetermined electrical characteristic when the associated diaper is wet is provided. A plurality of independent transmitters are each coupled to an associated one of the sensors. Each transmitter has a quiescent mode when the associated diaper is dry and a transmission mode when the associated diaper is wet. Each transmitter in a transmission mode transmits independent bursts of electromagnetic energy signals at respective intervals. A programming station is used to program each of the independent transmitters with an identification code responsive to the identification of a respective patient. Additionally, there is provided a receiver for receiving the electromagnetic energy signal transmissions from each of the plurality of independent transmitters that is in its transmission mode. Each electromagnetic energy signal transmission contains information responsive to the identification code of the associated transmitting independent transmitter. A control processor is used to process the information in each transmission.

The present invention consists essentially of four items, the first of which is a passive humidity sensor that changes from a high impedance to a low impedance state when the diaper is wet. In addition, this sensor is electrically connected to a pair of detachable connection means such as metallic or otherwise conductive button snaps (resembling clothing snaps), or to a pair of adhesive pads with a permanently tacky surface, or to a pair of electrically conductive pads situated about half an inch apart and located either on the outside or the inside of the diaper in the front near the top. In an advantageous embodiment, a pair of electrically conductive strips, as described later, could perform the dual function of wetness detector and connection means to the detachable connection means.

The second item is a small sealed and fully encapsulated unit about an inch square and a quarter of an inch thick containing two metal snaps, or other forms of detachably connection means, designed to attach to the two mating connectors on the front of the diaper. This second unit, a programmable transmitter module, is relatively inexpensive in cost but not low enough to be considered completely disposable with each diaper. The unit is expected to have a battery life of a year or two. In practice, when the diaper requires changing, the care giver will first detach the transmitter module from the soiled diaper and snap it on to the new one. The guardian will then remove the soiled diaper and discard it, along with the disposable humidity sensor. Lastly the guardian installs the new diaper, which has the transmitter module attached, and completes the operation in exactly the same manner as if the transmitter module were not present. With the exception of having to remove the transmitter module from the old diaper and installing it on a fresh one, the guardian is not burdened with any additional tasks. Guardians are very willing to trade off the slight inconvenience of having to transfer the completely sealed and unsoiled transmitter module to a new diaper, against having to undertake the unpleasant task of having to make several checks for wet diapers for every one that requires changing or leaving a baby unattended with a wet diaper that can cause rash or other medical problems.

The transmitter module contains an inexpensive battery and an electronic chip. None of the components, including the battery, is accessible to the outside, or replaceable. The unit consumes essentially no power from its internal battery as long as the humidity sensor item is dry. Thus, the battery life when the humidity sensor is dry is essentially the shelf life. When the humidity sensor detects moisture, the transmitter module emits short bursts of radio frequency signals for a period or about half a second and repeats this approximately every minute or two as long as it remains connected to the wet diaper. Under normal use it is envisaged that the diaper will be changed within a few minutes, so the power drain on the transmitter module will be very low, allowing the module to remain operative for several years with normal use. All modules transmit on the same frequency, but each has a different code embedded in the transmission. Short bursts of transmissions separated by relatively long wait periods serve to prevent signals from overlapping.

The third item is a receiver tuned to the frequency of the transmitter modules and capable of receiving and reading signals from any receiver module within its range. There may be several forms of receivers. Possibly the most popular one would be a small battery operated portable unit about two inches square carried on the belt of the guardian and capable of emitting a beep when it receives a signal from its dedicated transmitter. In most cases there would be only one transmitter within range. If there are several transmitters in close proximity, such as in hospitals, conflict between simultaneous, and therefore garbled, transmissions is avoided by several constraints. First of all there are only a small number of diapers that will be wet at the same time. Secondly since the transmitter modules are not synchronized for transmission times, and since each sends out very short bursts with long wait periods in between bursts and that only when a wet diaper is detected, it is extremely unlikely that the transmissions of two or more transmitter modules will be coincident in time, even if two or more diapers get wet at the same time. However there is always the possibility that two or more transmitters will send overlapping signals. There are algorithms available that permit decryption of garbled simultaneous transmissions. But even if the receivers are not so equipped they may simply retransmit the garbled signals allowing software in the computer to differentiate between garbled and valid signals. Or else the computer may simply wait until it receives a non-garbled signal. In day care centers the receiver unit will simply wait until it gets a set of clear signals if two diapers get wet at the same time. The transmitters, however, can be manufactured to have random quiescent periods between the transmission burst that vary slightly from one another. Thus, if two transmitters transmit simultaneously, they will not remain in synchrony for future transmissions.

The fourth item of this system is a computer that may be connected via cables or the power lines using commands that are similar to the widely used X-10 system. This will only be used in hospitals or large installations. The computer will interrogate the receiver units independently and absorb the information it receives. It will have the intelligence to differentiate between valid transmissions and invalid garbled ones, such as if two or more transmitter modules happen to overlap their transmissions. As mentioned earlier, since there is no synchronization between the various transmitter modules, it is unlikely that any two transmitter modules will continue to send time coincident bursts of signals.

As briefly mentioned earlier, the transmitter module may be programmable. It contains a non-volatile memory that can be programmed by the computer unit using a special adaptor that has a three pin contact unit (in addition to the two snaps mentioned earlier) on side of the module. The module snaps into place on the adaptor. Before use, the module is programmed with an individual code, delivered via the three pin contact unit and assigned by the computer. This links the code with the name of the patient.

When the computer receives a signal that indicates one of the diapers is wet, the data it receives contains a code that is specific to one particular transmitter, and the patient is thereby identified. If the patient is not at the bed, the care giver will need to locate the patient in the ward, but such would not create undue hardship since the care giver will know the identity of the patient. If a garbled unrecognizable code is received, in the unlikely event that two transmitter modules have transmitted at the same time, the computer will quickly recognize that fact. It will reject that garbled code and wait for the next transmission that will in all probability not be garbled, because the two reporting diapers are not synchronized.

Hospitals will in all probability discard the transmitter modules at the end of a patient's stay, even though it is not necessary to do so, because the modules can easily be sterilized.

Another, and probably much larger application for this product is use of the system by parents to monitor the condition of diapers. For this use, battery operated receivers are designed and constructed to permit them to be carried on the parent's belt. The receivers will vibrate, emit a sound, or provide a visible signal whenever the diaper is wet. The receivers can be carried by the parent their person anywhere in the house or outdoors. For the general consumer application such as this, there is no need for a computer. The portable receiver will be matched with the transmitter module in the following manner:

The portable receiver will have a “learn” switch, illustratively in the form of a button switch. Each of the transmitters will be programmed at manufacture with a different code, using a very large number of combinations that will avoid repetition. When the transmitter module is squeezed, a built-in switch is activated, causing the transmitter to transmit. If the “learn” button is depressed simultaneously, the receiver unit learns the code of the transmitter. Thenceforth the receiver unit will notify the parent only upon receipt of a signal from that particular transmitter. If the parent loses either the transmitter or the receiver he or she can readily can acquire a replacement for the lost item and re-program the receiver in the manner described herein.

An advantage of this system is that the radio frequency radiation is always very low powered and limited to the fraction of a second during each of the few bursts of transmission of the transmitter module.

In accordance with yet another aspect of the invention, there is provided a system for indicating the wetness condition of a diaper. The system has a sensor coupled to the diaper, the sensor having a first predetermined electrical characteristic when the associated diaper is dry and a second predetermined electrical characteristic when the diaper is wet. A confirmatory element that is externally accessible, and has a third predetermined electrical characteristic which remains unchanged when the diaper exhibits either the first or the second predetermined electrical characteristics, is also provided.

In one embodiment, the confirmatory element is a resistor. In a specific illustrative embodiment of the invention, the resistor has a resistance value of approximately ten thousand ohms.

In accordance with another aspect of the invention, there is provided system for transmitting electromagnetic energy, the system having a transmitter having first, second, and third electrical terminals for coupling with first and second external devices. The first external device is coupled to the first and second electrical terminals and has first and second electrical characteristics responsive to environmental conditions. The second external device is coupled to the second and third electrical terminals and has a substantially constant electrical characteristic. The transmitter operates to have a quiescent mode when the first external device exhibits the first electrical characteristic, and a transmission mode when the first external device exhibits the second electrical characteristic and the substantially constant electrical characteristic of the second external device is present across the second and third electrical terminals.

The transmitter transmits electromagnetic energy when in the transmission mode, and when the second predetermined electrical characteristic is present across the first and second electrical terminals simultaneously with the substantially constant electrical characteristic of the second external device being present across the second and third electrical terminals.

The first and second electrical characteristics of the first external device constitute different levels of impedance responsive to environmental humidity. The substantially constant electrical characteristic of the second external device constitutes a predetermined electrical impedance, which may be a predetermined electrical resistance value.

### BRIEF DESCRIPTION OF THE DRAWING

Comprehension of the invention is facilitated by reading the following detailed description, in conjunction with the annexed drawing, in which:

FIG. 1 is a simplified schematic representation of a diaper equipped with a humidity sensor;

FIG. 2 is a simplified schematic representation of the diaper of FIG. 1 with a transmitter module attached thereto;

FIG. 3 is a simplified schematic representation of a transceiver unit;

FIG. 4 is a simplified schematic representation of a generalized computer arrangement;

FIG. 5 is a simplified schematic representation in block and line form that is useful to describe the functioning of a transmitter module;

FIG. 6 is a simplified schematic representation of a programming adaptor;

FIG. 7 is a simplified schematic representation of a battery operated portable receiver;

FIG. 8. is a simplified schematic representation of a transmitter module;

FIG. 9 is a simplified schematic representation of a diaper equipped with a humidity sensor and a confirmatory resistor;

FIG. 10 is a simplified schematic representation of the inner surface of an outer layer of a diaper with two narrow conductive ink stripes placed longitudinally along the longitudinal dimension and with the stripes widened near the top of the diaper to facilitate contact with an external transmitter;

FIG. 11 is a simplified view of the inner surface of an outer layer of diaper of FIG. 10 wherein the widened stripes have been replaced by small disks of conductive plastic to form the contacts for facilitating external connection;

FIG. 12 is a simplified schematic representation of a side of a transmitter equipped with a hinged flap and having contacts on the inner surface of the flap, the flap being arranged to be mounted on the inside of the top of the diaper;

FIG. 13 is an enlarged simplified schematic representation of the transmitter arrangement substantially as shown in FIG. 12, but further showing a claw that is arranged to hold the transmitter in place on the diaper and that prevents the transmitter from sliding on the diaper;

FIG. 14 is an enlarged simplified schematic representation of the transmitter arrangement substantially as shown in FIG. 12, but further showing two mating corrugated elements that serve to prevent the transmitter from sliding on the diaper;

FIGS. 15(a) and 15(b) are simplified schematic representations of a front portion of an outer layer of a diaper showing two conductive ink stripes and two holes cut through the diaper layer at the top of the diaper, and a side view of the same diaper portion, respectively;

FIGS. 16(a), 16(b), and 16(c) are simplified schematic representations of a front portion of an outer layer of a diaper showing the addition of two pads of conductive adhesive, and a side views of the pads of conductive adhesive and of the diaper portion engaged with one another;

FIG. 17 is a simplified schematic representation of a transmitter configured to be attached to the pads of conductive adhesive shown in FIGS. 16(a), 16(b), and 16(c);

FIGS. 18(a), 18(b), and 18(c) are a simplified schematic representations of the front of an outer layer of a diaper, a separate plastic element having thereon the conductive adhesive with two clothing-type snaps at the termination of the stripes, and a side representation of the separate plastic element, respectively;

FIGS. 19(a) and 19(b) are a simplified schematic representations that illustrate the separate plastic element of FIG. 18(b) placed on the inner surface of the outer diaper layer of FIG. 18(a), and a side representation of the separate plastic element of the clothing type snaps protruding through the holes in an outer layer of the diaper, respectively;

FIG. 20 is a simplified schematic representation of a side view of a transmitter with clothing-type snaps affixed thereto that are configured to mate with the snaps on the diaper arrangement of FIG. 19(b);

FIG. 21 is a simplified schematic representation of the inside surface of an outer layer of a diaper having two electrically conductive stripes in the central portion and along the entire length thereof before the diaper has been crimped to form the openings for the legs of a user;

FIG. 22 is a simplified schematic representation of the inside surface of an outer layer of a diaper having two electrically conductive strips positioned in lateral displacement to one side of the central portion and along the entire length thereof; and

FIG. 23 is a simplified schematic representation of the inside surface of the diaper arrangement of FIG. 22, after a middle section thereof has been crimped to form leg openings for a user.

### DETAILED DESCRIPTION

FIG. 1 is a simplified schematic representation of a diaper 1 equipped with a humidity sensor 2. The diaper has two metal snaps 4 that, in this embodiment, are similar to the ones conventionally used on clothing. The snaps are connected to the humidity sensor by means of two fine enameled copper wires 3 embedded in the fabric of the diaper so they do are not visible from the outside and do not make physical contact with the body of the person wearing the diaper. The diaper, in this specific illustrative embodiment of the invention, contains the female portion of the snaps.

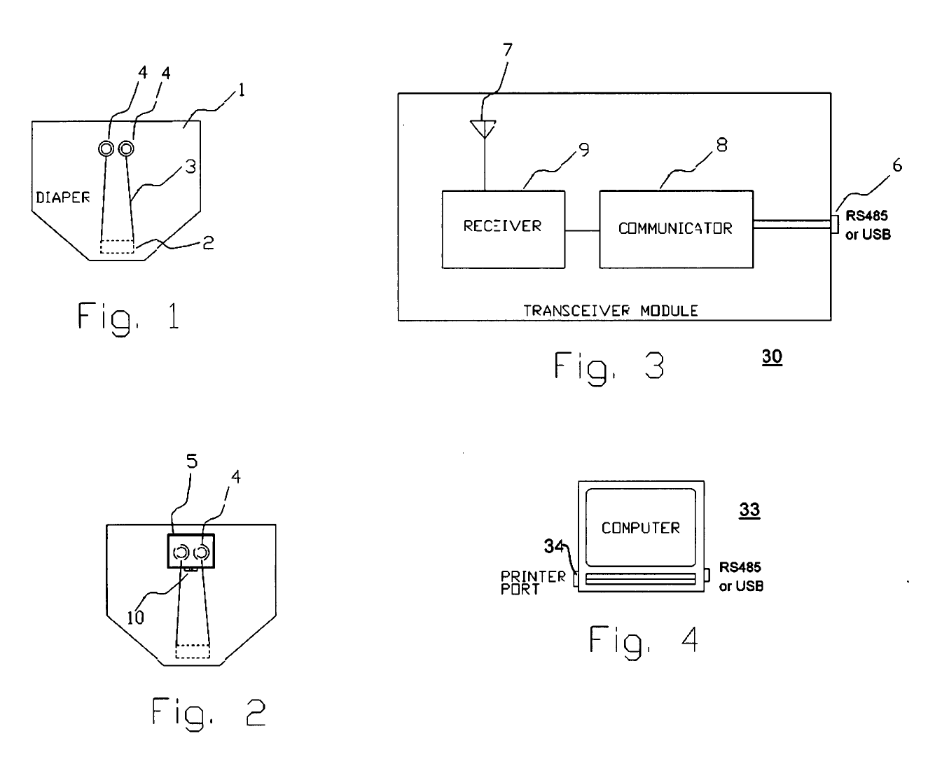

FIG. 2 is a simplified schematic representation of diaper 1 of FIG. 1 with a transmitter module 5 attached to it. Module 5, is only about an inch square. Module 5 is, in this embodiment, sealed to be water resistant. It is made of a plastic material capable of being sterilized. In this specific illustrative embodiment of the invention the module contains the male portion of the snaps. It also contains a set of three small closely spaced metallic buttons 10 that are used to deliver an individual code to a non-volatile memory (not shown) as will be described hereinbelow.

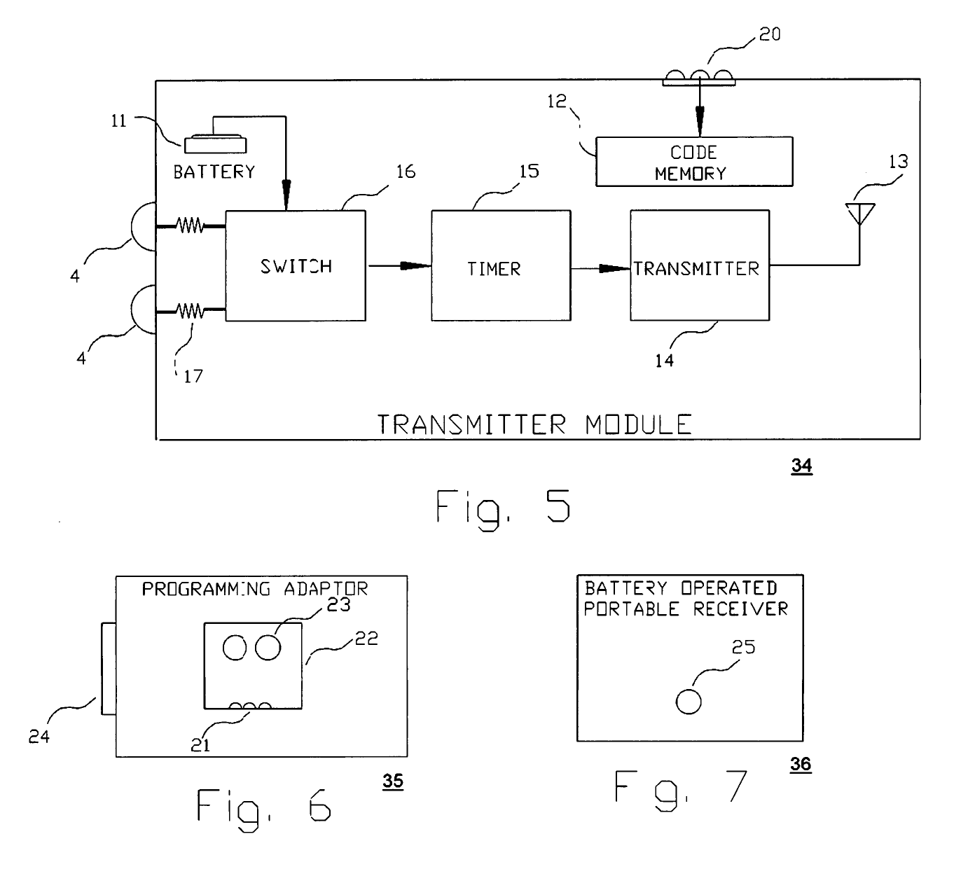

FIG. 3 is a simplified schematic representation of a transceiver unit 30. This transceiver unit can be placed in reasonably close proximity to the wearer of the diaper, illustratively on the order of 100 feet. In practice, there would be several of these transceiver units distributed in the hospital ward. Each transceiver unit 30 has a receiver 9 tuned to the common carrier frequency of the modules and a communicator 8 that communicates with a computer 33 shown in FIG. 4.

FIG. 4 is a simplified schematic representation of a personal computer 33. There are several ways in which one or more transceiver units 30 can communicate with computer 33. Referring for the moment to FIG. 3, each transceiver unit 30 has an associated connector 6 that can be daisy chained with the well-known RS485 port of computer 33. In some embodiments, the port may be a conventional USB port, and the transceivers would then be connected to computer 33 in accordance with the well-known USB interconnection scheme. Alternatively, other communications protocols may be employed, including, for example, the common X-10 system, or any of several forms of wireless communication.

FIG. 5 is a simplified schematic representation that shows certain details of a transmitter module 34. A pair of snaps 4 are disposed on the outside of the transmitter module. The snaps are shown to be connected to switch 16, which in this specific illustrative embodiment of the invention is a MOS (metal oxide silicon) device well known to the electronic industry. Switch 16 exhibits a high impedance to its internal switch apparatus when there is a high resistance or open circuit between the snaps. When the diaper gets wet, a low impedance is present between the snaps. This changes the conductivity of switch 16, to a low impedance. Steady power is thus delivered from the battery, 11, to a timer 15. The power lasts as long as the diaper is wet and enables the timer to operate.

Timer 15 in turn is designed to send power to a transmitter 14 in short bursts. The timer is also a MOS device requiring extremely low power. It remains in an “on” condition as long as humidity sensor 2 is in the wet state. Timer 15, which is formed of MOS components common well known to those in the electronic industry, is designed to present a low impedance, in this specific illustrative embodiment of the invention, for about half a second at intervals of a minute or two. The periodic low impedance is similar in effect to the pushing of a button switch on a remote control device. It provides power to transmitter 14 and to a non-volatile code memory, 12. Transmitter 14 is designed to transmit the code from the memory 12 using a transmitter antenna 13, which, because of the high carrier frequency, is very small and embedded in the walls (not shown) of a plastic module (not shown) that houses the transmitter module.

Transmitter module 34 operates in a manner similar to a remote control “clicker” of the type used to open the doors or trunk of an automobile (not shown). Code memory 12 is connected to three metal tabs 20 that are shown to be accessible on the outside of the transmitter module. The purpose of these tabs is to enable code memory 12 to be programmed with a unique individual number, by means of programming adaptor 35 described hereinbelow in connection with FIG. 6. Programming is achieved using methodology well known to the electronic industry. Two resistors 17, serve to protect the transmitter module against electrostatic charges that may develop in the handling of the unit.

FIG. 6 is a simplified schematic representation of a programming adaptor 35. As shown, programming adaptor 35 contains a rectangular depression 22 in the same shape as transmitter module 34. The transmitter module is accommodated in rectangular depression 22. Additionally, there are provided two snaps 23 within rectangular depression 22, the snaps being similar to snaps 4 described above on diaper 1. There are also provided three contacts 21 that communicate electrically with metal tabs 20 on the transmitter module 34. Programming adaptor 35 is, in this specific illustrative embodiment of the invention, electrically connected at its printer port 24 to printer port 34 of computer 33 shown in FIG. 6.

In an actual application of this technology in a hospital, the care giver would snap one of the transmitter modules into the programming adaptor and enter the name or the patient on the computer screen in the space provided (not shown). The computer would then load a specific code into the code memory to establish a relationship between the patient and the newly entered code. The care giver would then take the programmed transmitter module and attach it to the diaper being used for that patient.

Later, when the diaper becomes wet, the humidity sensor energizes the transmitter module, which in turn transmits a code to one of the transceiver units. Whenever any one or more of the transceivers receives a wet diaper call, it communicates that fact to the computer. The computer has the intelligence to evaluate the data and to determine whether the codes are valid. The computer additionally analyzes the data to determine the name of the patient requiring attention. If a garbled code is received, as might be the case when two transmitters transmit simultaneously, the computer will wait for additional transmissions.

FIG. 7 is a simplified schematic representation of a battery operated portable receiver 36. In consumer applications with parents and babies and day care centers, the transmitter modules could be programmed differently than as described above. In such embodiments, each transmitter would be manufactured with a respective unique permanently programmed code. The numerical combinations would be so large that they would not be repeated for many years. In this embodiment, the three programming tabs described above would be absent from the transmitter modules. Instead the transmitter modules would have a small internal switch (not shown) that would be activated by squeezing the transmitter module. This switch would force the module to transmit.

The battery operated portable receiver 36 shown in FIG. 7, has a learn button 25. When learn button 25 is depressed at the same time as the transmitter module is squeezed, the receiver would learn the code it is receiving. That process individualizes the transmitter-receiver combination. A similar method could be used to program a multi-unit receiver (not shown) used in day care centers.

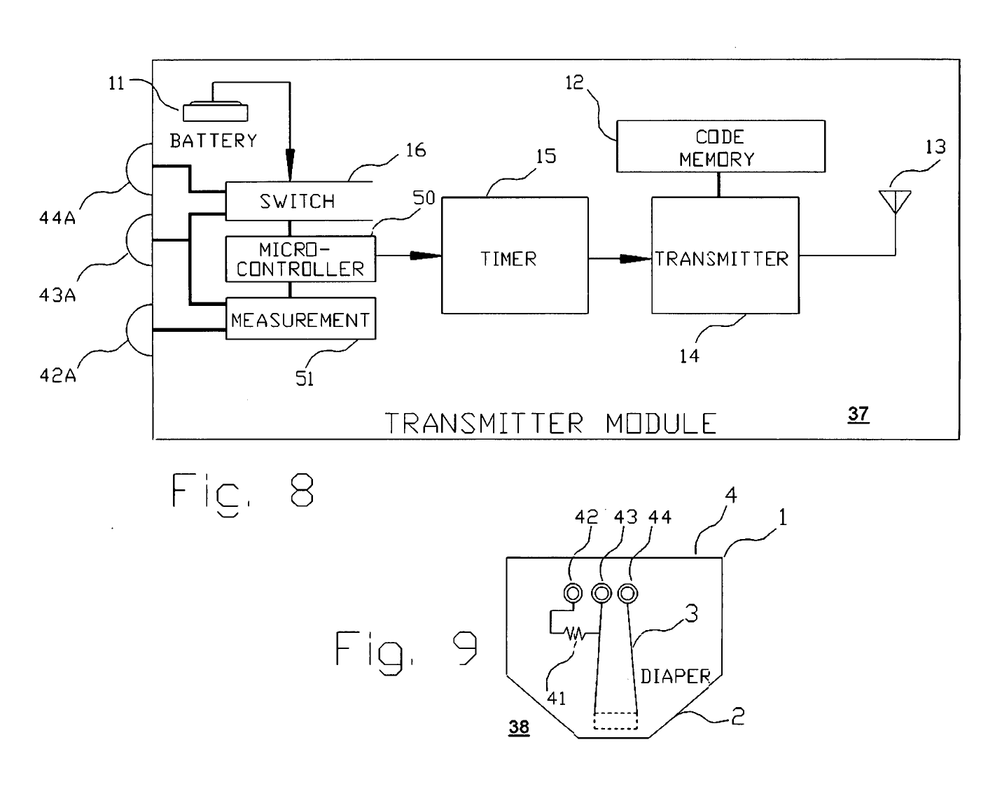

FIG. 8. is a simplified schematic representation of a transmitter module 37. Elements of structure that bear correspondence to those already discussed are similarly designated. In this specific illustrative embodiment of the invention, module 37 has three snaps, 42A, 43A, and 44A disposed on the outside of the transmitter module and designed to make electrical contact with respective snaps 42, 43, and 44 disposed on the diaper 38 (see, FIG. 9). When installed on the diaper, snap 42 contacts snap 42A, snap 43 contacts snap 43A, and snap 44 contacts snap 44A. This specific illustrative embodiment of the module of the invention module has two additional elements over that described in FIG. 5, specifically a microcontroller 50 and a measurement arrangement 51.

In FIG. 8, snaps 43A and 44A function as described above in connection with snaps 4 of FIG. 5. Referring to FIG. 8, in order to prevent unwanted transmissions which could occur when the transmitter is not attached to the diaper and terminals 43A and 44A erroneously detect a characteristic that would indicate a wet diaper (for instance when it is being washed), a confirmatory check is conducted by the transmitter module. This confirmatory check consists of measuring the electrical characteristic between terminals 43A and 44A, using any one of the measurement techniques well-known in the electronics industry, before tripping the timer 15.

The sequence of operation is as follows. When the switch detects a change in characteristics between the snaps 43A and 44A microcontroller 50 is notified of the event.

The microcontroller then commands measurement arrangement 51 to measure the resistance between snaps 42A and 43A. If the microcontroller deems the measurement to be within the specified limits (within a predetermined tolerance of the expected value), the microcontroller triggers timer 15, in the same manner as described earlier and this results in the sequence of events that are identical to those described earlier. For simplicity of explanation, protective resistors 17, which are not essential to the operation of the unit, have not been described in connection with this specific illustrative embodiment of the invention.

FIG. 9 is a simplified schematic representation of a specific illustrative embodiment of the invention showing diaper 1 having a humidity sensor 2 and a confirmatory resistor 41.

Elements of structure that bear correspondence to those already discussed are similarly designated. Confirmatory resistor 41 is of a predetermined value and is connected between terminals 42 and 43. In this embodiment, this component is a resistor but such is not intended to limit the invention. The measured element may instead be a capacitor (not shown), an inductor (not shown), or a combination of such elements.

FIG. 10 is a simplified schematic representation of the inner surface of an outer layer of a diaper 67 with two narrow conductive ink stripes placed longitudinally along the longitudinal dimension and with the stripes widened near the top of the diaper to facilitate contact with an external transmitter. As shown in this figure, after the diaper is completely manufactured and installed on the baby, bottom edge 55 of diaper 67 will be wrapped around leg openings 68 and be level with top 54 of the diaper. Electrically conductive ink stripes 56 are deposited on the inner surface of this outer layer.

There are several different ways of constructing the conductive ink stripes. One method is to deposit ink directly on the inner surface of outer layer 67 of the diaper and to cure it on the diaper manufacturing machine or an external printer. Another method of constructing the stripes is to start with narrow (approximately one quarter of an inch wide), strips of film on which cured ink is already deposited, and to glue these strips to the inner surface of outer diaper layer 67. In the practice of the invention, the method of fabrication will be determined by the particular manufacturing procedure to be used.

A layer of absorbent material, not shown for clarity, is lightly glued to the inner surface of this outer layer over the conductive ink stripes. The absorbent material communicates with electrically conductive ink stripes 56. When the absorbent layer is dry, the impedance between the two conductive stripes is very high. When the absorbent layer is wet, it becomes conductive and reduces the impedance between conductive ink stripes 56. The stripes of conductive ink therefore perform as both, wetness detector 2 in FIG. 1, and as connection means 3, also in FIG. 1. Even though the absorbent layer, because of its presence, participates in the function of the wetness detector, it is not a necessary part of it. Liquid, such as water, poured between the stripes would cause a similar reduction in impedance between the stripes. Near the top of diaper 54, the widened part of conductive stripes 53 facilitate alignment with transmitter contacts 63, as will be described in connection with FIG. 12. This embodiment does not require holes to be made in the outer surface of the diaper.

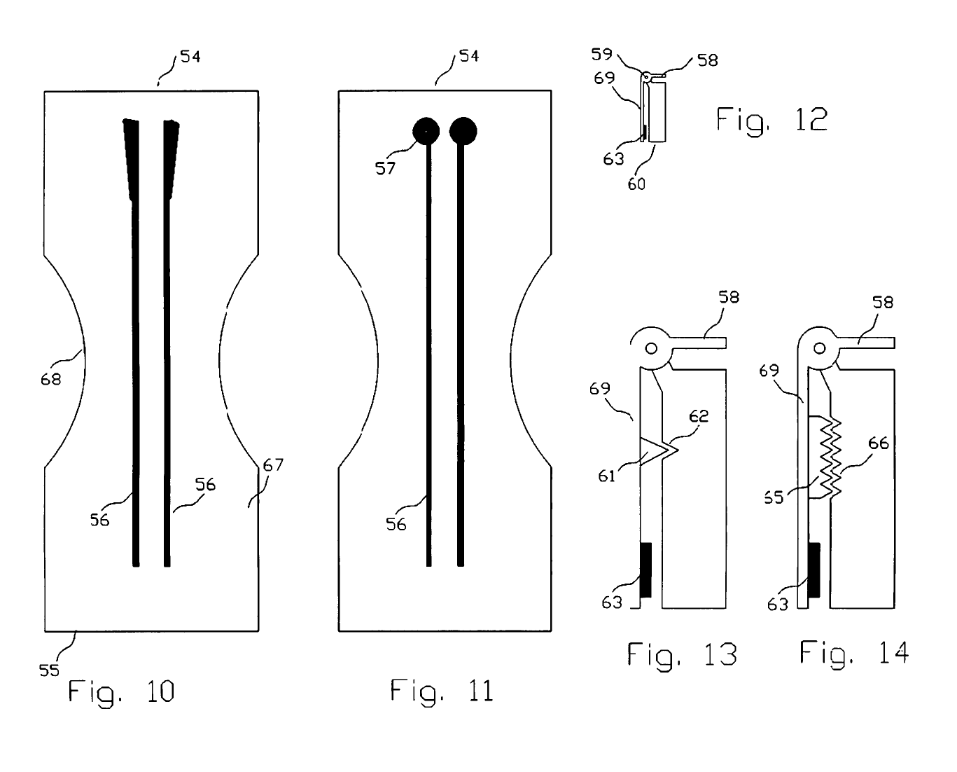

FIG. 11 is a simplified view of the inner surface of an outer layer of the diaper of FIG. 10 wherein the widened stripes have been replaced by small disks of conductive plastic to form the contacts for facilitating external connection. As shown in this figure, the widened portions of the conductive ink 53 have been replaced with respective ones of disks 57, which are formed of conductive material. In this embodiment, the disks are formed of a film of conductive plastic coated with conductive adhesive (not specifically identified). These disks form the electrical connections which contact is made to an external transmitter (not shown in this figure). This embodiment does not require that holes be made through an outer layer of the diaper.

FIG. 12 is a simplified schematic representation of a side of a transmitter equipped with a hinged flap and having contacts on the inner surface of the flap, the flap being arranged to be mounted on the inside of the top of the diaper. In this specific illustrative embodiment of the invention, a spring under tension (not shown in this figure) pulls flap 69 towards the body of transmitter 60. The flap is opened by squeezing an actuator 58 towards the body of the transmitter. This action pushes the flap away from the body of the transmitter. In use, the transmitter is detachably installed over top edge 54 of the diaper (not shown in this figure) by first opening flap 69 and laying hinge 59 over top edge 54 of the diaper. The flap therefore is disposed on the inside of the diaper with transmitter body 60 on the outside front of the diaper. An outer layer of diaper 67 therefore is located between the flap and the body of the transmitter. Tabs 63, which are disposed on the inside surface of the flaps, communicate electrically with either widened stripes 53 or conductive disks 57, depending on the specific illustrative embodiment of the invention under consideration. Alternatively, in certain embodiments of the invention the flap is mounted on the outside of the diaper and the transmitter on the inside the diaper. In such a configuration, tabs 63 are installed directly on the transmitter, avoiding the need to include the connections around the hinge. The spring mechanism (not shown) is in some embodiments replaced by two magnetic strips, one of which mounted on the inside surface of the transmitter and the other on the inside surface of the flap. When the flap is brought near to the transmitter, the magnetic strips are magnetically attracted to each other and consequently apply pressure between the conductive ink stripes and tabs 63. This enhances the electrical communication. In a specific illustrative embodiment of the invention, the entire flap is constructed of magnetic material, thereby obviating the need for an actuator and providing the further advantage of enabling the flexible flap to conform to the contour of the inside surface of the transmitter.

FIG. 13 is an enlarged simplified schematic representation of the transmitter arrangement substantially as shown in FIG. 12, but further showing a claw 61 that is arranged to hold the transmitter in place on the diaper (not shown in this figure) and that prevents the transmitter from sliding on the diaper. Claw 61 is attached to the inside surface of flap 69. The claw engages aggressively with the diaper and prevents it from sliding on the diaper. As shown, the claw mates with a depression 62 on the body of the transmitter. When it is desires to install the transmitter for use, the installer (not shown in this figure) first straddles the transmitter mechanism with the flap open, as herein described, over the top edge of the diaper. The diaper layer would then be located between flap, 69 and transmitter body 60. The installer then squeezes flap 69 towards the body of the transmitter, whereby the claw pierces film 67. The sloped edges of the claw facilitate the removal of the transmitter, which is effected by squeezing actuator 58 to open the flap. If the edges of the claw were perpendicular to the flap, the material forming the outer surface of the diaper would simply remain attached to the claw. The sloped edges of the claw permit the pierced diaper layer to slide easily off of the claw when the transmitter and flap are moved in the upward direction. However, in order to ensure good electrical connection, contacts 63 are configured to communicate with conductive ink 53, or the conductive tabs 57, as the case maybe, before the claw fully engages receptacle 62 on the body of the transmitter.

FIG. 14 is an enlarged simplified schematic representation of the transmitter arrangement substantially as shown in FIG. 12, but further showing two mating corrugated elements 65 and 66, respectively, that serve to prevent the transmitter from sliding on the diaper (not shown in this figure). As shown in this figure, claw 61 of FIG. 13 has been replaced by a three dimensional corrugated surface 65, which has a mating counterpart 66 disposed on the body of the transmitter. The film that forms an outer layer of diaper 67 (not shown in this figure) lies between the flap and the body of the transmitter. The components are constructed such that, when the transmitter is installed by squeezing the flap on the transmitter, contacts 63 engage conductive ink stripes 56 (FIG. 10) or conductive tabs 57 (FIG. 11) before corrugated surface 65 fully engages corrugated surface 66, to ensure good electrical communication. Once the film has been distorted by the squeezing action, the spring (not shown in this figure) that pulls the flap towards the body of the transmitter maintains good electrical contact between the transmitter and the diaper.

Since contact areas 53 or 57 are disposed on the inside of the diaper and therefore not externally visible, in one embodiment of the invention a rectangular figure, resembling the outline of the transmitter, is printed on the outside of the diaper to facilitate proper positioning of the transmitter and the registration of the contacts.

FIGS. 15(a) and 15(b) are simplified schematic representations of a front portion of an outer layer of a diaper showing two conductive ink stripes and two holes cut through the diaper layer at the top of the diaper, and a side view of the same diaper portion, respectively; FIG. 15(a) shows the inner surface of outer layer 75 of a diaper with two conductive ink stripes 73 deposited thereon. Near the top of diaper 80 there are provided two holes 74. FIG. 15(b) is a side view of the diaper.

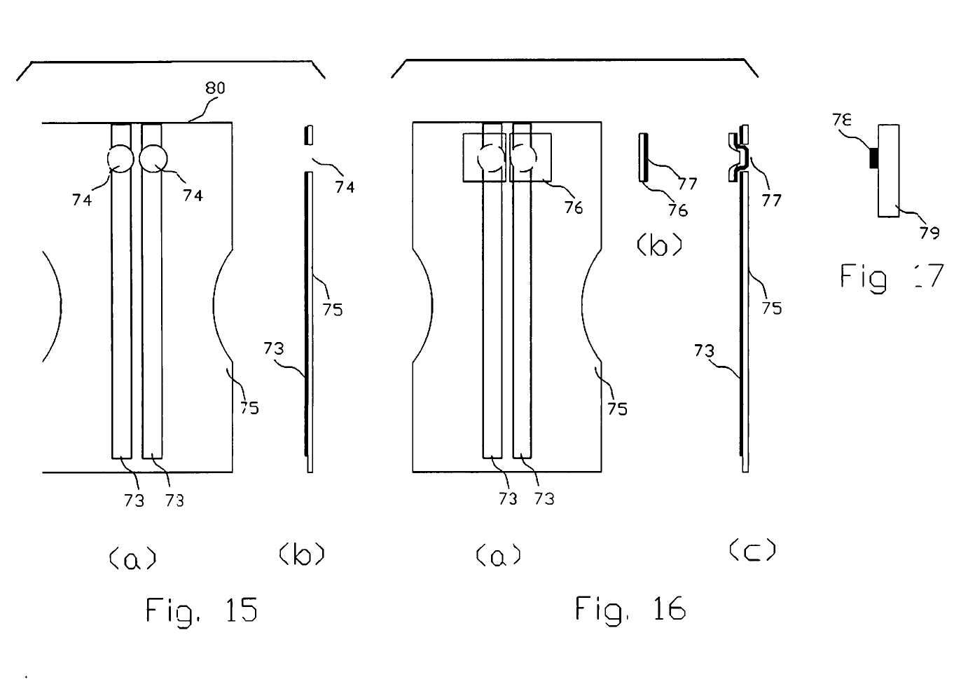

FIGS. 16(a), 16(b), and 16(c) are simplified schematic representations of a front portion of an outer layer of a diaper showing the addition of two pads of conductive adhesive, and a side views of the pads of conductive adhesive and of the diaper portion engaged with one another. FIG. 16(a) shows the same inner surface of an outer layer of the diaper, with two electrically conductive adhesive tabs near the top of the diaper. FIG. 16(b) shows a side view of the tabs, consisting of a flexible film 76 on which is deposited an electrically conductive adhesive 77. The electrically conductive adhesive remains permanently tacky, and may in certain embodiments of the invention be similar in nature to amtape marketed under the trade name Scotch Tape, except that the adhesive is electrically conductive. Flexible film 76 of the tabs is shown in FIG. 16(a). Electrically conductive adhesive layer 77 is arranged to communicate with the electrically conductive ink and is accessible to the contacts on the transmitter through the holes 74, as shown in FIG. 16(c).

FIG. 17 is a simplified schematic representation of a transmitter configured to be attached to the pads of conductive adhesive shown in FIGS. 16(a), 16(b), and 16(c). There is shown in this figure a transmitter body 79 together with two contacts 78 that are designed to be detachably attached to tacky conductive adhesive 77. In use, the transmitter is aligned so that its contacts 78 register with holes 74 of the diaper. Pressure is then applied by placing two fingers (not shown) inside the diaper behind the films 76 and a thumb (not shown) on the front surface of the transmitter. Removal of the transmitter is effected simply by pulling same apart from the diaper.

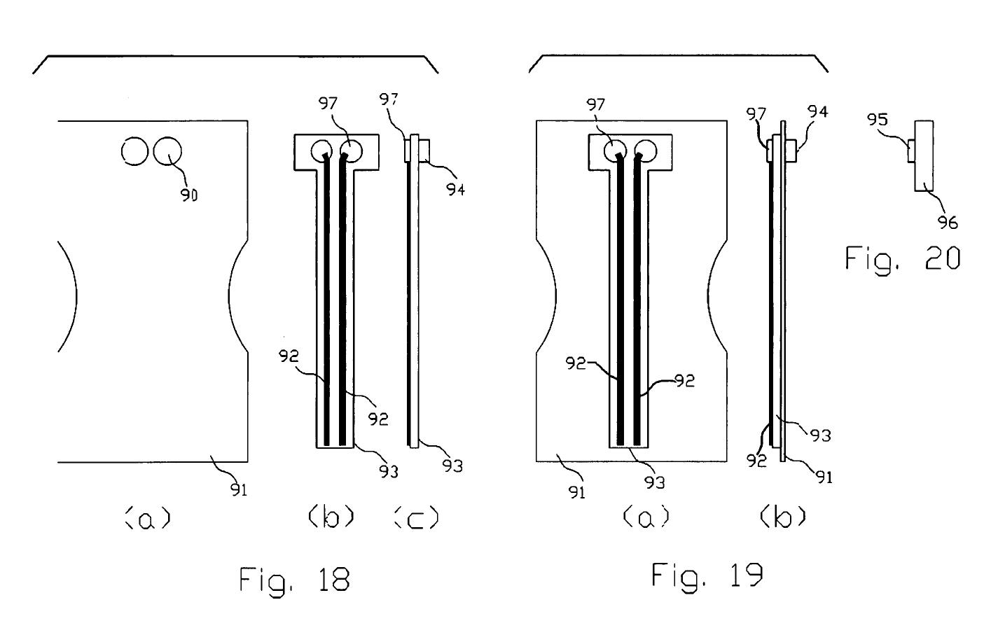

FIGS. 18(a), 18(b), and 18(c) are a simplified schematic representations of the front of an outer layer of a diaper, a separate plastic element having thereon the conductive adhesive with two clothing-type snaps at the termination of the stripes, and a side representation of the separate plastic element, respectively. FIG. 18(a) illustrates the inner surface of outer layer 91 of a diaper having two holes 90 disposed near the top. FIG. 18(b) is a representation of a flexible nonconductive T-shaped strip 93 on which has been deposited two stripes of electrically conductive ink 92. In a further specific illustrative embodiment of the invention, uninsulated bare wires are used to terminate electrically at the top with two conductive clothing-type snaps 94 and 97. In this embodiment, the conductive clothing-type snaps are riveted to strip 93. Clothing-type snaps 94 and 97 are constructed in two pieces that are riveted together. Element 97 communicates with the conductive ink. The other element forms the female component of snap and is configured to mate with male component 95 mounted on the transmitter.

FIGS. 19(a) and 19(b) are simplified schematic representations that illustrate the separate plastic element of FIG. 18(b) placed on the inner surface of an outer diaper layer of FIG. 18(a), and a side representation of the separate plastic element of the clothing type snaps protruding through the holes in the outer layer of the diaper, respectively. Elements of structure that have previously been described are similarly designated. FIG. 19(a) shows a flexible strip installed on the diaper, the flexible strip being held in place with a light adhesive, not shown. Female element of snap 94 protrudes through holes 90 and permits the transmitter to be detachably attached to the diaper. FIG. 19(b) shows clothing-type snaps 94 and 97 protruding beyond outer surface 91 while electrically engaged with electrically conductive ink 92.

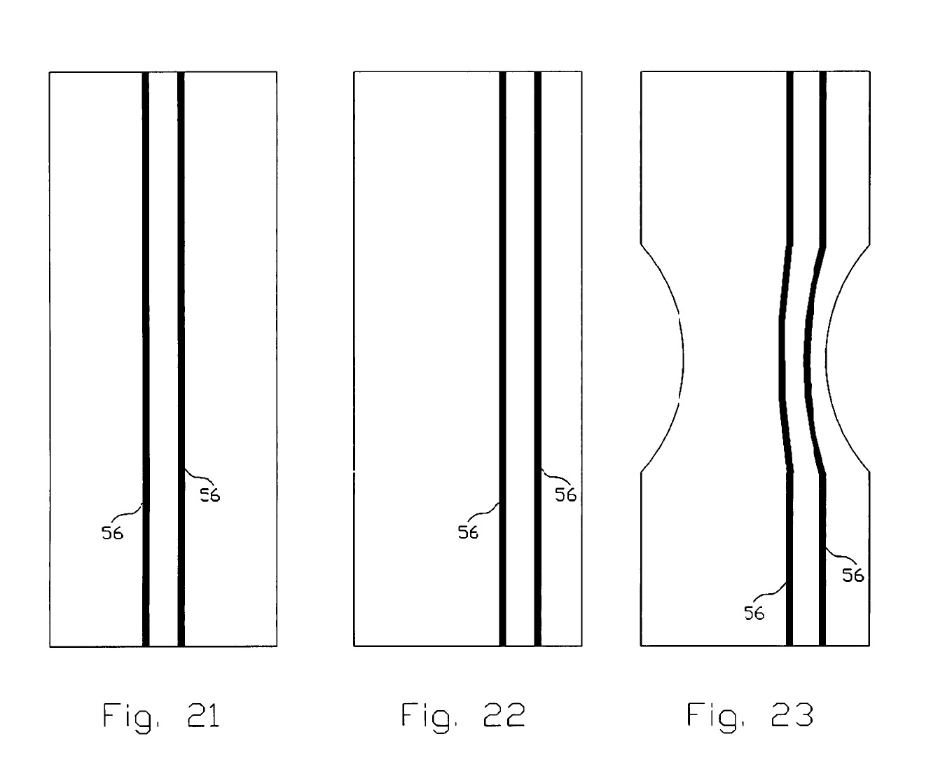

FIG. 20 is a simplified schematic representation of a side view of a transmitter with clothing-type snaps affixed thereto that are configured to mate with the snaps on the diaper arrangement of FIG. 19(b). As shown, a transmitter body 96 has provided thereon male element 95 of the clothing-type snap.

FIG. 21 is a simplified schematic representation of the inside surface of an outer layer of a diaper having two electrically conductive stripes in the central portion and along the entire length thereofbefore the diaper has been crimped to form the openings for the legs of a user. The electrically conductive ink stripes in this specific illustrative embodiment of the invention occupy the entire length of an outer layer. This configuration permits the outer layer, which starts off as a long continuous film on a roll, to be manufactured on a printing machine (not shown) instead of a diaper machine (not shown). The printing machine would deposit the ink as continuous lines along the entire length of the roll. The roll, after it is processed with the ink stripes, is then installed on the diaper machine without requiring modification of the diaper machine. This is an important manufacturing consideration that additionally permits the curing time of the electrically conductive ink to be tailored to the printing process rather than to the speed of known diaper machines that conventionally operate at a rate of approximately nine hundred feet per minute. Since in this configuration there will not be a widened end to the conductive ink stripes, the registration between tabs 63 and conductive ink stripes 56 is facilitated by forming tabs 63 wider.

FIG. 22 is a simplified schematic representation of the inside surface of an outer layer of a diaper having two electrically conductive strips positioned in lateral displacement to one side of the central portion and along the entire length thereof.

FIG. 23 is a simplified schematic representation of the inside surface of the diaper arrangement of FIG. 22, after a middle section thereof has been crimped to form leg openings for a user. This figure shows an outer layer after the middle portion has been crimped to form the leg openings. The ink lines follow the contour of the crimping process. This allows tabs 57, and therefore the transmitter (not shown in this figure) to be located on the side of the person wearing the diaper, instead of the middle front. A side installation of the transmitter may be preferable for babies who tend to lie on their stomachs or their backs. Even when the babies lie on their sides, their pelvic bones support their weight with very little pressure on the waistline.

The technology herein described additionally applies to underpads. Underpads are generally rectangular and flat, and about two feet square. They are placed on beds beneath the bed sheet and under the patient, as opposed to being installed on the body of the patient. Underpads have an impervious lower layer, above which is placed an absorbent layer and above the absorbent layer there is provided a protective porous layer. This is similar in structure to diapers and designed for the same purpose, i.e., incontinence.

Although the invention has been described in terms of specific embodiments and applications, persons skilled in the art may, in light of this teaching, generate additional embodiments without exceeding the scope or departing from the spirit of the claimed invention. Accordingly, it is to be understood that the drawing and description in this disclosure are proffered to facilitate comprehension of the invention, and should not be construed to limit the scope thereof.

1. A system for monitoring the wetness condition of a diaper, the system comprising:
a sensor coupled to the diaper, said sensor having a first predetermined electrical characteristic when the associated diaper is dry and a second predetermined electrical characteristic when the associated diaper is wet;
a transmitter disposed within a transmitter housing that is detachably installable on the diaper, said transmitter, when installed on the diaper, being electrically coupled to said sensor, said transmitter being in a quiescent mode when said sensor is characterized by the first predetermined electrical characteristic and in a transmission mode when said sensor is characterized by the second predetermined electrical characteristic, said transmitter transmitting electromagnetic energy signals when in the transmission mode;
a receiver for receiving the electromagnetic energy signal transmissions from said transmitter when said transmitter is in the transmission mode; and
a coupling arrangement for simultaneously coupling said transmitter housing onto the diaper and forming the electrical coupling between said transmitter in the transmitter housing and said sensor.

2. The system of claim 1, wherein said coupling arrangement comprises a snap arrangement formed of first and second detachably engaging portions, the first engaging portion being installed on the diaper and electrically coupled to said sensor, and the second engaging portion being installed on said transmitter and electrically coupled thereto.

3. The system of claim 2, wherein the first engaging portion is a female conductive portion of the snap arrangement and the second engaging portion is a male conductive portion of the snap arrangement.

4. The system of claim 1, wherein said coupling arrangement is provided with a clamping arrangement having a magnetic strip.

5. The system of claim 4, wherein said clamping arrangement is provided with a further magnetic strip configured to be magnetically attracted to said magnetic strip.

6. The system of claim 1, wherein said sensor comprises first and second electrically conductive elements arranged in predetermined spatial relationship to one another.

7. The system of claim 6, wherein said first and second electrically conductive elements respectively comprise first and second elements of electrically conductive ink.

8. The system of claim 7, wherein at least one of said first and second elements of electrically conductive ink comprises an electrically conductive ink stripe.

9. The system of claim 7, wherein said coupling arrangement communicates electrically with at least one of said first and second elements of electrically conductive ink.

10. The system of claim 7, wherein said first and second elements of electrically conductive ink are disposed on an inner surface of the diaper.

11. The system of claim 10, wherein the transmitter housing of said transmitter is provided with an adjustable contact arrangement for engaging at least one of said first and second elements of electrically conductive ink on the inner surface of the diaper.

12. The system of claim 11, wherein said transmitter housing of said transmitter is further provided with a clamping arrangement for reducing sliding of said transmitter along the diaper.

13. The system of claim 12, wherein said clamping arrangement is incorporated with said adjustable contact arrangement.

14. The system of claim 13, wherein said first and second elements of electrically conductive ink and said adjustable contact arrangement are configured to facilitate clamping of said transmitter to a predetermined location along the diaper.

15. The system of claim 14, wherein the predetermined location includes a location along the diaper corresponding to the side of a wearer of the diaper.

16. The system of claim 15, wherein there is provided a marking on the diaper to indicate the predetermined location along the diaper for the clamping of said transmitter.

17. The system of claim 1, wherein said transmitter is provided with a visual indicator responsive to said transmitter being in the transmission mode.

18. The system of claim 1, wherein the transmitter housing in which said transmitter is contained is a sealed housing.

19. The system of claim 1, wherein said receiver is arranged to be portable.

20. The system of claim 19, wherein said receiver is battery operated.

21. The system of claim 1, wherein said transmitter issues an identifier code when in the transmission mode, the identifier code being encoded in the electromagnetic energy signals.

22. The system of claim 21, wherein said receiver is arranged to produce a human readable indication associated with said transmitter in response to the identifier code.

23. A system for monitoring a diaper, the system comprising:
a sensor associated with the diaper, the sensor having a first predetermined electrical characteristic when the associated diaper is dry and a second predetermined electrical characteristic when the associated diaper is wet;
a transmitter detachably installed on the diaper and coupled electrically to said sensor, said transmitter having a quiescent mode responsive to said sensor when the associated diaper is dry and a transmission mode responsive to said sensor when the associated diaper is wet, said transmitter transmitting a unique identification code within the electromagnetic energy signals that are transmitted when said transmitter is in the transmission mode; and
a receiver for receiving the electromagnetic energy signal signals from said transmitter and issuing a perceptible indication, the perceptible indication being responsive exclusively to the identification code transmitted by the transmitter.

24. The system of claim 23, wherein said sensor comprises first and second electrically conductive elements arranged in predetermined spatial relationship to one another.

25. The system of claim 24, wherein said first and second electrically conductive elements respectively comprise first and second elements of electrically conductive ink.

26. The system of claim 25, wherein said first and second elements of electrically conductive ink are disposed on an inner surface of the diaper.

27. The system of claim 26, wherein said transmitter is provided with an adjustable contact arrangement for engaging at least one of said first and second elements of electrically conductive ink on the inner surface of the diaper.

28. The system of claim 23, wherein the electromagnetic energy signals are in the radio frequency range.

29. The system of claim 23, wherein the electromagnetic energy signals are in the infrared frequency range.

30. The system of claim 23, wherein said receiver is portable.

31. The system of claim 23, wherein there is further provided a coupling arrangement for simultaneously coupling said transmitter onto the diaper and forming an electrical coupling between said transmitter and said sensor.

32. The system of claim 23, wherein said transmitter is contained in a sealed housing that is detachable from the diaper.

33. The system of claim 32, wherein there is further provided a coupling arrangement for simultaneously coupling the sealed housing onto the diaper and forming the electrical coupling between said transmitter in the sealed housing and said sensor.

34. The system of claim 33, wherein said coupling arrangement comprises a clamping arrangement for reducing sliding of said transmitter along the diaper.

35. The system of claim 23, wherein there is further provided a coupling arrangement for simultaneously coupling said transmitter housing onto the diaper and forming the electrical coupling between said transmitter and said sensor, said coupling arrangement being provided with a clamping arrangement having a magnetic strip.

36. The system of claim 35, wherein said clamping arrangement is provided with a further magnetic strip configured to be magnetically attracted to said magnetic strip.

37. A system for monitoring a plurality of diapers, each diaper being worn by a respective one of a plurality of patients, the system comprising:
a plurality of sensors, each associated with a respective one of the diapers, each sensor having a first predetermined electrical characteristic when the associated diaper is dry and a second predetermined electrical characteristic when the associated diaper is wet;
a plurality of independent transmitters, each coupled to an associated one of the sensors, each transmitter having a quiescent mode when the associated diaper is dry and a transmission mode when the associated diaper is wet, each transmitter in a transmission mode transmitting independently bursts of electromagnetic energy signals at respective intervals; and
a receiver for receiving the electromagnetic energy signal transmissions from each of said plurality of independent transmitters that is in its transmission mode, each electromagnetic energy signal transmission containing information responsive to a transmitter identification code of the respective transmitting independent transmitter.

38. The system of claim 37, wherein said sensor comprises first and second electrically conductive elements arranged in predetermined spatial relationship to one another.

39. The system of claim 38, wherein said first and second electrically conductive elements respectively comprise first and second elements of electrically conductive ink.

40. The system of claim 37, wherein there is further provided a transmitter identification code generator in each of said plurality of independent transmitters for generating the associated transmitter identification code.

41. The system of claim 37, wherein there is further provided a programming station for programming each of said independent transmitters with a patient identification code responsive to the identification of a respectively associated patient.

42. The system of claim 37, wherein there is further provided a control processor for processing the information in each transmission.

43. A system for monitoring a plurality of diapers, each diaper being worn by a respective on of a plurality of patients, the system comprising:
a plurality of sensors, each associated with a respective one of the diapers, each sensor having a first predetermined electrical characteristic when the associated diaper is dry and a second predetermined electrical characteristic when the associated diaper is wet;
a plurality of independent transmitters, each coupled to an associated one of the sensors, each transmitter having a quiescent mode when the associated diaper is dry and a transmission mode when the associated diaper is wet, each transmitter in a transmission mode transmitting independently bursts of electromagnetic energy signals at respective intervals;
a programming station for programming each of said independent transmitters with an identification code responsive to the identification of a respective patient;
a receiver for receiving the electromagnetic energy signal transmissions from each of said plurality of independent transmitters that is in its transmission mode, each electromagnetic energy signal transmission containing information responsive to the identification code of the associated transmitting independent transmitter; and
a control processor for processing the information in each transmission.

44. A system for indicating the wetness condition of a diaper, the system comprising:
a sensor coupled to the diaper, said sensor having a first predetermined electrical characteristic when the associated diaper is dry and a second predetermined electrical characteristic when the diaper is wet; and
a confirmatory element, externally accessible, with a third predetermined electrical characteristic which remains unchanged when the diaper exhibits either the first or the second predetermined electrical characteristics.

45. The system of claim 44, wherein said confirmatory element is a resistor.

46. The system of claim 45, wherein the resistor has a resistance value of approximately ten thousand ohms.

47. A system for transmitting electromagnetic energy, the system comprising a transmitter having first, second, and third electrical terminals for coupling with first and second external devices, the first external device being coupled to the first and second electrical terminals and having first and second electrical characteristics responsive to environmental conditions, and the second external device being coupled to the second and third electrical terminals and having a substantially constant electrical characteristic, said transmitter having a quiescent mode when the first external device exhibits the first electrical device, and a transmission mode when the first external device exhibits the second electrical characteristic and the substantially constant electrical characteristic of the second external device is present across the second and third electrical terminals.

48. The system of claim 47, wherein said transmitter transmits electromagnetic energy when in the transmission mode, and when the second predetermined electrical characteristic is present across the first and second electrical terminals simultaneously with the substantially constant electrical characteristic of the second external device being present across the second and third electrical terminals.

49. The system of claim 47, wherein the first and second electrical characteristics of the first external device constitute different levels of impedance responsive to environmental humidity.

50. The system of claim 47, wherein the substantially constant electrical characteristic of the second external device constitutes a predetermined electrical impedance.

51. The system of claim 50, wherein the substantially constant electrical characteristic of the second external device constitutes a predetermined electrical resistance.

52. A system for monitoring the wetness condition of a diaper, the system comprising:
a sensor coupled to the diaper, said sensor having a first predetermined electrical characteristic when the associated diaper is dry and a second predetermined electrical characteristic when the associated diaper is wet;
a transmitter disposed within a transmitter housing that is detachably installable on the diaper, said transmitter, when installed on the diaper, being electrically coupled to said sensor, said transmitter being in a quiescent mode when said sensor is characterized by the first predetermined electrical characteristic and in a transmission mode when said sensor is characterized by the second predetermined electrical characteristic, said transmitter transmitting electromagnetic energy signals when in the transmission mode; and
a coupling arrangement for simultaneously coupling said transmitter housing onto the diaper and forming the electrical coupling between said transmitter in the transmitter housing and said sensor.

53. The system of claim 52, wherein there is further provided a receiver for receiving the electromagnetic energy signal transmissions from said transmitter when said transmitter is in the transmission mode.

54. A diaper comprising:
first and second electrical terminals accessible on a surface of the diaper; and
a wetness sensor installed within the diaper and coupled electrically between said first and second electrical terminals, said wetness sensor having a first predetermined electrical characteristic when the diaper is dry and a second predetermined electrical characteristic when the diaper is wet.
